(19) United States
(12) Patent Application Publication
(10) Pub. No.: US 2018/0213096 A1
(43) Pub. Date: Jul. 26, 2018

(54) Screen Display Apparatus That Continuously Executes Obtaining of Display Data, and Recording Medium Therefor

(71) Applicant: Kyocera Document Solutions Inc., Osaka (JP)

(72) Inventors: Yumi Nakagoshi, Osaka (JP); Zhenyu Sun, Osaka (JP); Tatsuya Hiwatari, Osaka (JP)

(21) Appl. No.: 15/878,447

(22) Filed: Jan. 24, 2018

(30) Foreign Application Priority Data
Jan. 24, 2017 (JP) 2017-009944

(51) Int. Cl. H04N 1/00

(52) U.S. Cl. CPC H04N 1/00411; H04N 2201/0094; H04N 1/00464; H04N 1/00474

(57) ABSTRACT

A screen display apparatus includes a display device, a display control unit, and a display data obtaining unit. The display data obtaining unit executes a sequence of processes from a request of the display data to a source to obtaining of the display data from the source for a plurality of items of the display data without performing parallel process. The display data obtaining unit continuously executes obtaining of the display data for each of a plurality of the screens in a group in sequence until the obtaining of the display data for every screen in the group is completed when the obtaining of the display data for the screen in the group is started.

### INCORPORATION BY REFERENCE

This application is based upon, and claims the benefit of priority from, corresponding Japanese Patent Application No. 2017-009944, filed in the Japanese Patent Office on Jan. 24, 2017, and the entire contents of which are incorporated herein by reference.

### BACKGROUND

Unless otherwise indicated herein, the description in this section is not prior art to the claims in this application and is not admitted to be prior art by inclusion in this section.

There has been known a typical screen display apparatus that obtains display data for a screen matched with log information from a source regardless of whether transition to the screen is instructed when the log information such as an operation log of a user satisfies a predetermined condition. The screen display apparatus transitions the screen based on display data when the display data for a screen as a transition destination has been already obtained from a source at a time point where the transition of the screen is instructed.

### SUMMARY

A screen display apparatus according to one aspect of the disclosure includes a display device, a display control unit, and a display data obtaining unit. The display control unit controls display of a screen on the display device. The display data obtaining unit obtains display data from a source of the display data for the screen. In a case where the display data for the screen as a transition destination has been already obtained by the display data obtaining unit, the display control unit transitions the screen on the display device based on the display data when a specific condition for the transition of the screen on the display device occurs. The display data obtaining unit executes a sequence of processes from a request of the display data to the source to obtaining of the display data from the source for a plurality of items of the display data without performing parallel process. The display data obtaining unit starts obtaining the display data for the screen in a group when the display control unit displays the screen of a first page in the group, the group is a specific group constituted of a plurality of the screens. The display data obtaining unit continuously executes the obtaining of the display data for each of the plurality of the screens in the group in sequence until the obtaining of the display data for every screen in the group is completed when the obtaining of the display data for the screen in the group is started.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 is a block diagram illustrating an MFP according to one embodiment of the disclosure.

FIG. 2 illustrates an exemplary manual transition screen group displayed on a display according to the one embodiment.

FIG. 3 illustrates an exemplary automatic transition screen group displayed on the display according to the one embodiment.

FIG. 4 illustrates functions achieved by a control unit according to the one embodiment.

FIG. 5 illustrates an exemplary region in a RAM according to the one embodiment.

FIG. 6 illustrates an operation of an MFP according to the one embodiment when only one screen is displayed on the display.

FIG. 7 illustrates an exemplary operation of the MFP according to the one embodiment when display data obtaining sequential processes are executed for a respective plurality of items of display data in a parallel process.

FIG. 8 illustrates an operation of the MFP according to the one embodiment when the display data obtaining sequential processes are executed for the plurality of items of the display data without performing the parallel process.

FIG. 9 illustrates an operation of obtaining the display data from a storage unit by the MFP according to the one embodiment when a screen in a copy help screen group is displayed on the display.

FIG. 10 illustrates an operation of the MFP according to the one embodiment when the screen in the copy help screen group is displayed on the display.

FIG. 11 illustrates an operation of obtaining the display data from the storage unit by the MFP according to the one embodiment when a screen in a standby screen group is displayed on the display.

FIG. 12 illustrates an operation of the MFP according to the one embodiment when the screen in the standby screen group is displayed on the display.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes one embodiment of the disclosure with reference to the drawings.

First, a configuration of a multifunction peripheral (MFP) as a screen display apparatus according to the embodiment will be described.

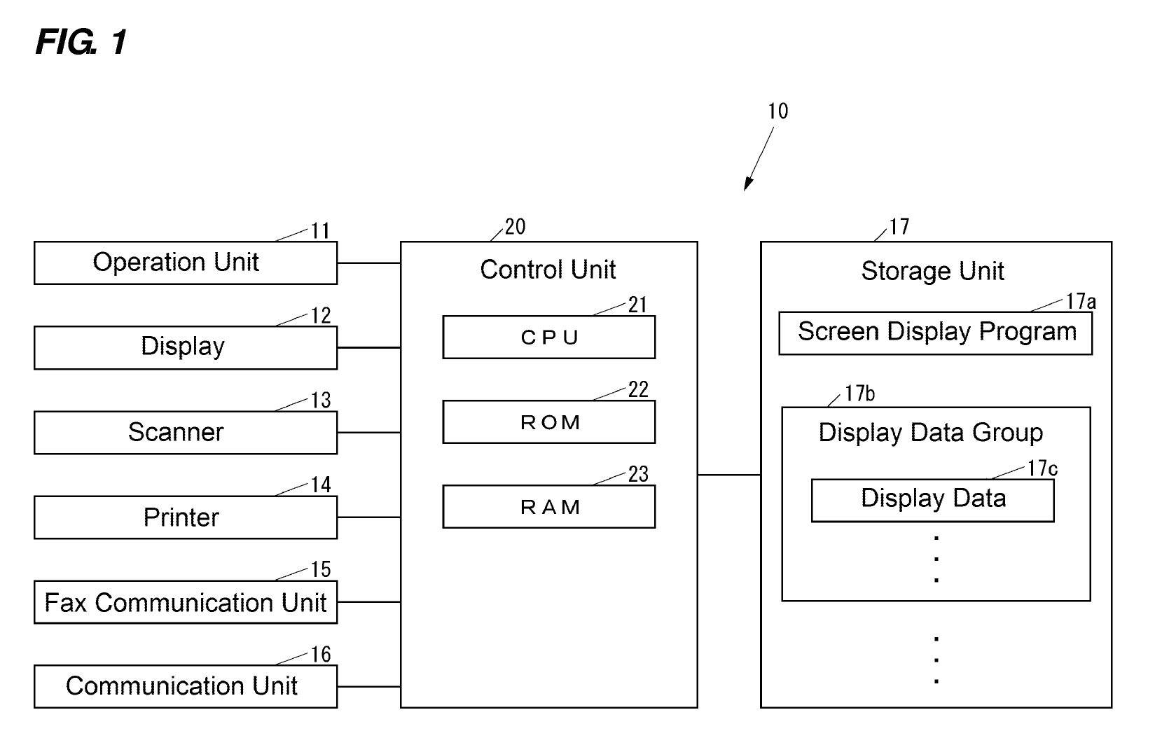

FIG. 1 is a block diagram illustrating an MFP 10 according to the embodiment.

As illustrated in FIG. 1, the MFP 10 includes an operation unit 11, a display 12, a scanner 13, a printer 14, a fax communication unit 15, a communication unit 16, a storage unit 17, and a control unit 20. The operation unit 11 is an input device such as buttons for inputting various kinds of operations. The display 12 is a display device such as a liquid crystal display (LCD) for displaying various kinds of information. The scanner 13 is a reading device for reading an image from an original document. The printer 14 is a print device for printing the image on a recording medium such as a paper sheet. The fax communication unit 15 is a facsimile device for carrying out fax communication with an external fax device (not illustrated) via a communication line such as a dial-up line. The communication unit 16 is a communication device for communicating with external devices via a network such as a local area network (LAN) or the Internet, or communicating directly by wired communication or wireless communication without being via a network. The storage unit 17 is a non-volatile storage device such as a semiconductor memory and a hard disk drive (HDD) for storing various kinds of information. The control unit 20 controls overall operation of the MFP 10.

At least a part of the operation unit 11 may configure a touch panel with the display 12.

The storage unit 17 may be included in the MFP 10, or at least a part of the MFP 10 may be constituted of an external storage medium, such as an SD card, removably attachable to the MFP 10.

The storage unit 17 stores a screen display program 17a to display a screen on a display device. The screen display program 17a may be installed onto the MFP 10 at a production stage of the MFP 10, may be additionally installed onto the MFP 10 from an external storage medium such as a universal serial bus (USB) memory, or may be additionally installed onto the MFP 10 from the network.

The storage unit 17 is configured to store a display data group 17b as a group of display data 17c of for a screen on the display 12. That is, the storage unit 17 configures a source of obtaining the display data 17c by the control unit 20. The display data 17c is data of a web page.

The screen configures specific groups including a plurality of screens. The display data group 17b is included in each screen group. As varieties of the screen groups, for example, a manual transition screen group that transitions the screen when an instruction of the screen transition on the display 12 is input to the operation unit 11, and an automatic transition screen group that automatically transitions the screen when it reaches a specific timing for the screen transition on the display 12.

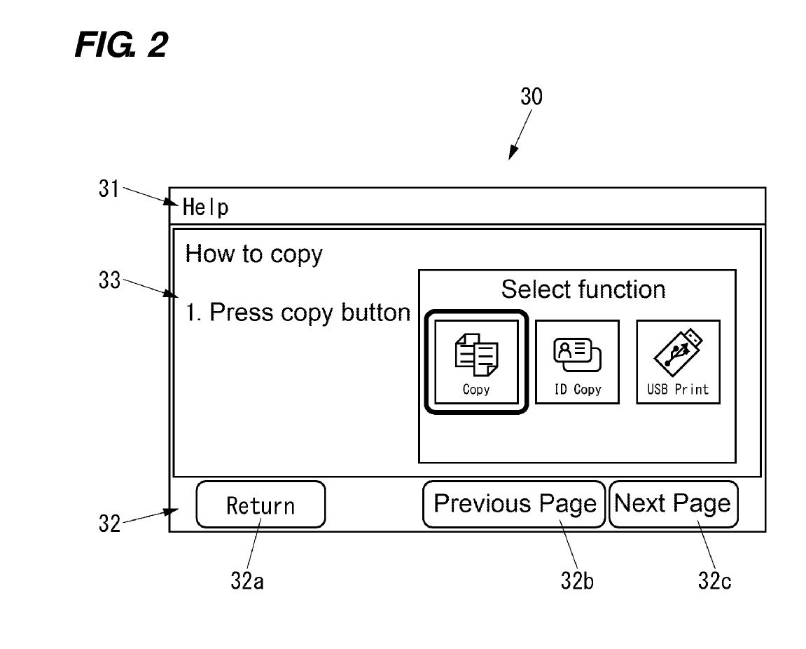

FIG. 2 illustrates an exemplary manual transition screen group displayed on the display 12.

The manual transition screen group includes, for example, a help screen group to provide information on a method for using the MFP 10 to a user. Especially, the manual transition screen group illustrated in FIG. 2 is a copy help screen group to provide information on a method for copying by the MFP 10 to the user. A screen 30 in the copy help screen group illustrated in FIG. 2 includes a title display area 31, an operation accepting area 32, and a content display area 33. The title display area 31 is arranged on an upper end portion and displays a title of the screen 30. The operation accepting area 32 is arranged on a lower end portion and accepts an input by the operation unit 11. The content display area 33 is arranged between the title display area 31 and the operation accepting area 32, and indicates how to execute copying with the MFP 10.

In FIG. 2, the title display area 31 displays the title as “Help” indicating that the screen 30 is a help screen.

The operation accepting area 32 includes a Return button 32a, a previous page button 32b, and a next page button 32c. The Return button 32a terminates the display of the screen in the copy help screen group on the display 12. The previous page button 32b is a transition instruction accepting region that accepts an input of an instruction via the operation unit 11 to transition to a screen of a previous page of a currently displayed screen as an instruction of a screen transition on the display 12. The next page button 32c is a transition instruction accepting region that accepts an input of an instruction via the operation unit 11 to transition to a screen of a next page to the currently displayed screen as an instruction of a screen transition on the display 12.

The content display area 33 may include a text and an image. The contents indicated by the respective content display areas 33 of a plurality of the screens in the copy help screen group may be changed to any contents by an administrator of the MFP 10.

The respective plurality of the screens in the copy help screen group only have different contents indicated on the content display areas 33, and have the contents indicated on the title display areas 31 and the operation accepting areas 32 in common. Accordingly, when the display data for the screen of a first page in the copy help screen group includes the data for the title display area 31, the operation accepting area 32, and the content display area 33, in a configuration where the control unit 20 uses data for the title display area 31 and the operation accepting area 32 in the display data for the screen of the first page in the copy help screen group even on the screen of another page in the copy help screen group, the display data for the screens of a second and subsequent pages in the copy help screen group may simply include only the data for the content display area 33 without including the data for the title display area 31 and the operation accepting area 32.

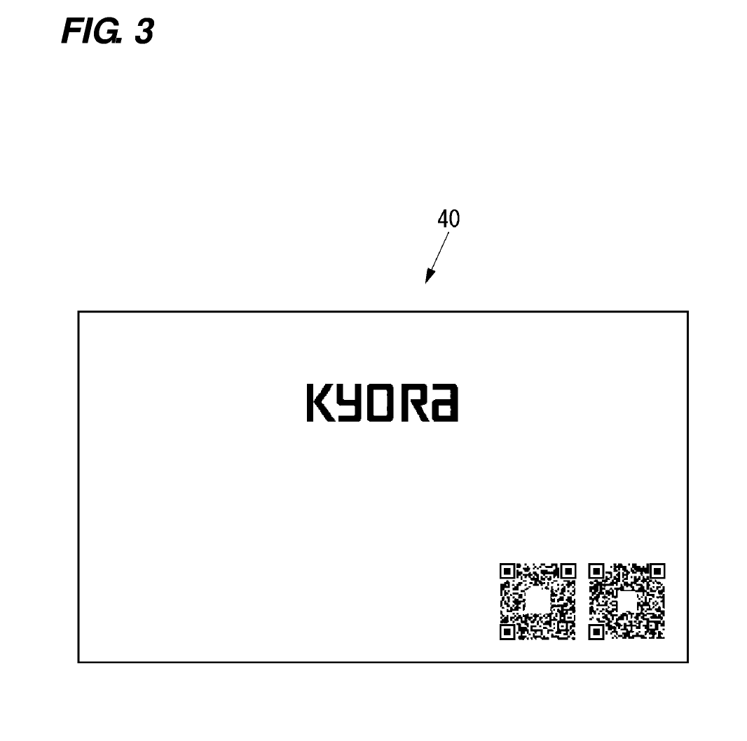

FIG. 3 illustrates an exemplary automatic transition screen group displayed on the display 12.

The automatic transition screen group includes, for example, a standby screen group that starts a display of a screen on the display 12 when no operation is accepted by the operation unit 11 for a specific period of time while a specific screen is displayed on the display 12. FIG. 3 illustrates an exemplary screen 40 in the standby screen group. In the standby screen group, a currently displayed screen automatically transitions to a screen of a next page at constant time intervals. The contents indicated by the respective plurality of the screens in the standby screen group may be changed to any contents by the administrator of the MFP 10. The content indicated on the screen in the standby screen group is, for example, advertising.

The control unit 20 illustrated in FIG. 1 includes, for example, a central processing unit (CPU) 21, a read-only memory (ROM) 22 that stores programs and various kinds of data, and a random-access memory (RAM) 23 used as a work region for the CPU 21. The CPU 21 executes the programs stored in the ROM 22 or the storage unit 17.

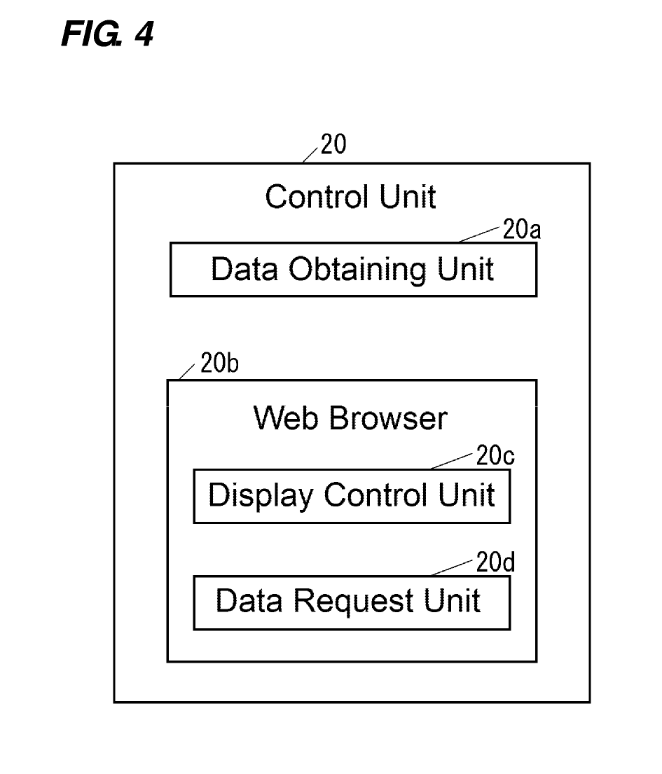

FIG. 4 illustrates functions achieved by the control unit 20.

As illustrated in FIG. 4, the control unit 20 executes the screen display program 17a (see FIG. 1) to achieve a data obtaining unit 20a that obtains the data from the storage unit 17, and a web browser 20b that displays a web page on the display 12. The web browser 20b includes a display control unit 20c that controls a display of the screen on the display 12, and a data request unit 20d that requests the display data for the screen on the display 12 to the data obtaining unit 20a. The data obtaining unit 20a and the data request unit 20d collaborate to obtain the display data for the screen on the display 12 from the storage unit 17, thus configuring a display data obtaining unit of the disclosure.

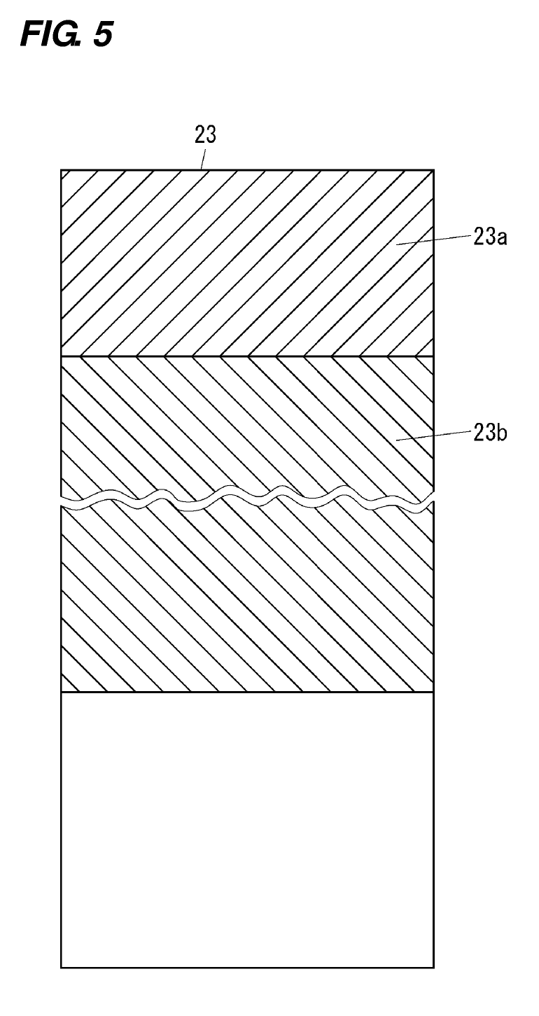

FIG. 5 illustrates an exemplary region in the RAM 23.

As illustrated in FIG. 5, the control unit 20 generates a display data obtaining work region 23a and a display data storage region 23b on the RAM 23. The display data obtaining work region 23a is used by the data obtaining unit 20a and the data request unit 20d to execute a sequence of processes (hereinafter referred to as “a display data obtaining sequential process”) from a request of the display data to the storage unit 17 to obtaining the display data from the storage unit 17. The display data storage region 23b stores the display data obtained from the storage unit 17. The display data obtaining work region 23a is a region having a fixed size or a region having a size where an upper limit is fixed.

The following describes the operation of the MFP 10.

First, a description will be given of the operation of the MFP 10 when only one screen is displayed on the display 12.

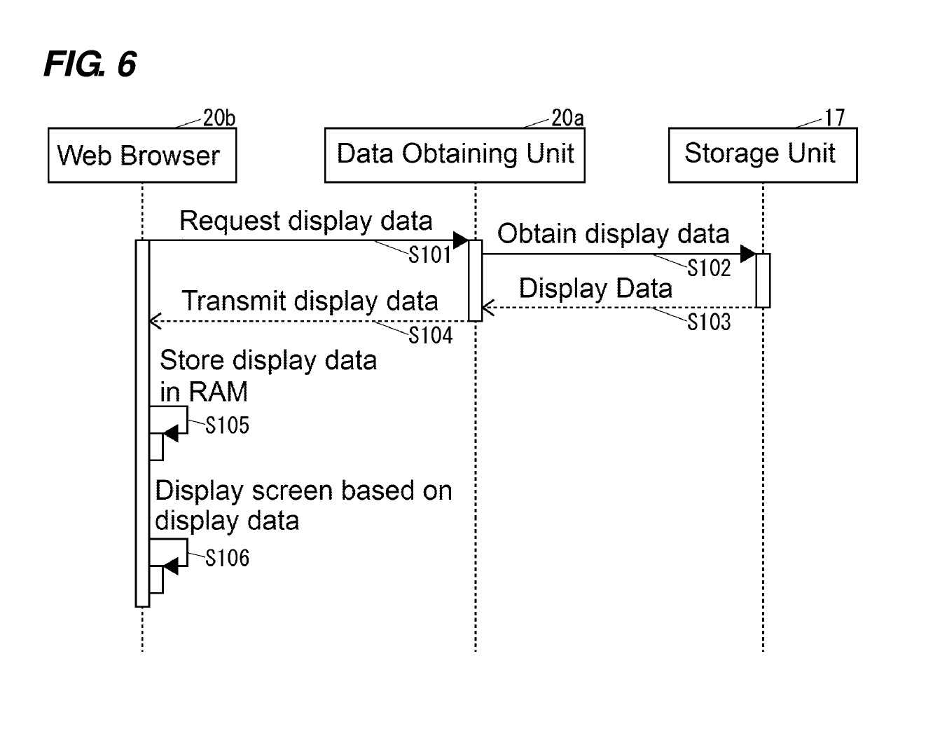

FIG. 6 illustrates the operation of the MFP 10 when only one screen is displayed on the display 12.

As illustrated in FIG. 6, the data request unit 20d of the web browser 20b request the data obtaining unit 20a for the display data for the screen to be displayed on the display 12 (Step S101). Then, the data obtaining unit 20a obtains the display data 17c of the screen to be displayed on the display 12 from the storage unit 17 (Steps S102 and S103), and transmits the display data obtained from the storage unit 17 to the data request unit 20d (Step S104). Here, Steps S101 to S104 correspond to the display data obtaining sequential process.

When the display data is transmitted in Step S104, the data request unit 20d causes the display data storage region 23b of the RAM 23 to store the display data transmitted in Step S104 (Step S105). Then, the display control unit 20c of the web browser 20b causes the display 12 to display the screen based on the display data stored in the display data storage region 23b in Step S105 (Step S106).

The following describes the operation of the MFP 10 when the display data obtaining sequential processes are executed for a plurality of items of the display data.

As described later, the control unit 20 executes the display data obtaining sequential processes for the plurality of items of the display data without performing the parallel process. However, for further understanding of the disclosure, first, a description will be given of a case where it is assumed that the control unit 20 executes the display data obtaining sequential processes for the plurality of items of the display data in the parallel process.

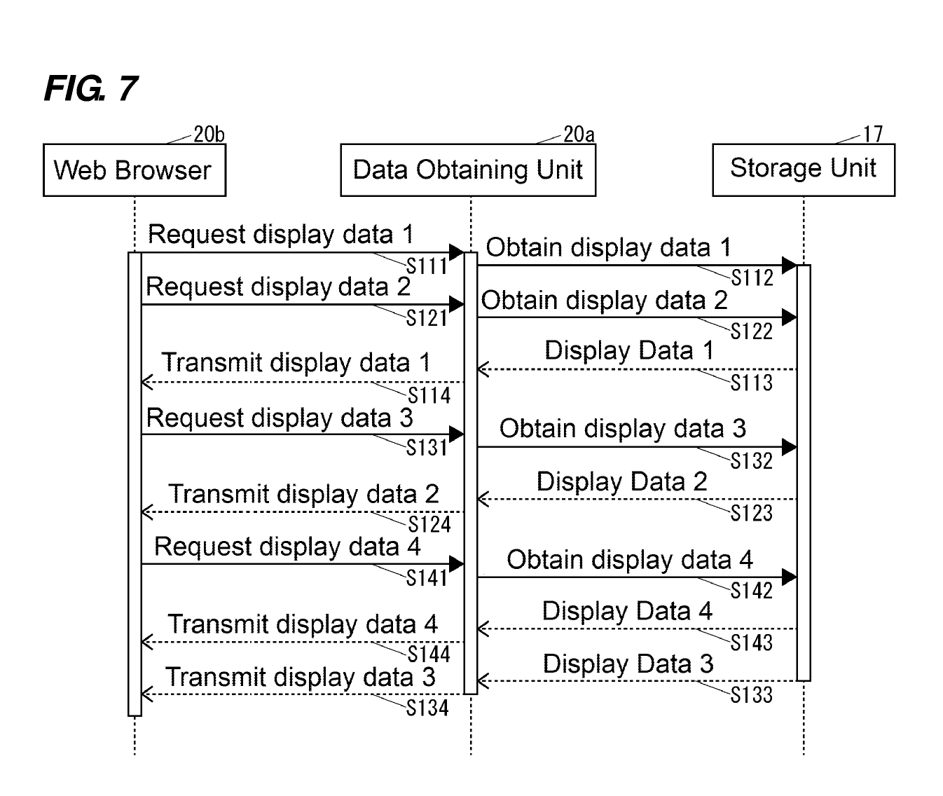

FIG. 7 illustrates an exemplary operation of the MFP 10 when the display data obtaining sequential processes are executed for the plurality of items of display data in the parallel process.

In FIG. 7, the control unit 20 executes the display data obtaining sequential process for display data 1 (Steps S111 to S114), the display data obtaining sequential process for display data 2 (Steps S121 to S124), the display data obtaining sequential process for display data 3 (Steps S131 to S134), and the display data obtaining sequential process for display data 4 (Steps S141 to S144). Here, the display data obtaining sequential process for the display data 1 and the display data obtaining sequential process for the display data 2 are performed in the parallel process. The display data obtaining sequential process for the display data 2 and the display data obtaining sequential process for the display data 3 are performed in the parallel process. The display data obtaining sequential process for the display data 3 and the display data obtaining sequential process for the display data 4 are performed in the parallel process.

When the display data is large in size, it takes a long time for the display data obtaining sequential process for this display data, thus raising the possibility that the display data obtaining sequential process for this display data and the display data obtaining sequential process for the other display data obtained from the storage unit 17 after this display data are performed in the parallel process. Especially, when among two items of the display data continuously requested from the data request unit 20d to the data obtaining unit 20a, the previously requested display data is considerably large in size compared with the later requested display data, the two items of the display data are possibly transmitted from the data obtaining unit 20a to the data request unit 20d in a reversed order, similarly to the display data obtaining sequential process for the display data 3 and the display data obtaining sequential process for the display data 4 illustrated in FIG. 7.

The examples of the display data having a large size include the display data including a photograph and similar item, such as the display data for a help screen and the display data for an advertising screen.

As illustrated in FIG. 7, when the control unit 20 executes the display data obtaining sequential processes for the plurality of items of the display data in the parallel process, performances of the CPU 21 and the RAM 23, which are used by the control unit 20 to execute the display data obtaining sequential process, are insufficient to cause an error in some cases. For example, when the control unit 20 executes the display data obtaining sequential processes for the plurality of items of the display data in the parallel process, the display data obtaining work region 23a of the RAM 23 is insufficient in size to cause the error in some cases. When such error occurs, the display data fails to be read from the storage unit 17 to the display data storage region 23b of the RAM 23, thus failing to transition the screen on the display 12.

Accordingly, in the disclosure, the control unit 20 executes the display data obtaining sequential processes for the plurality of items of the display data without performing the parallel process.

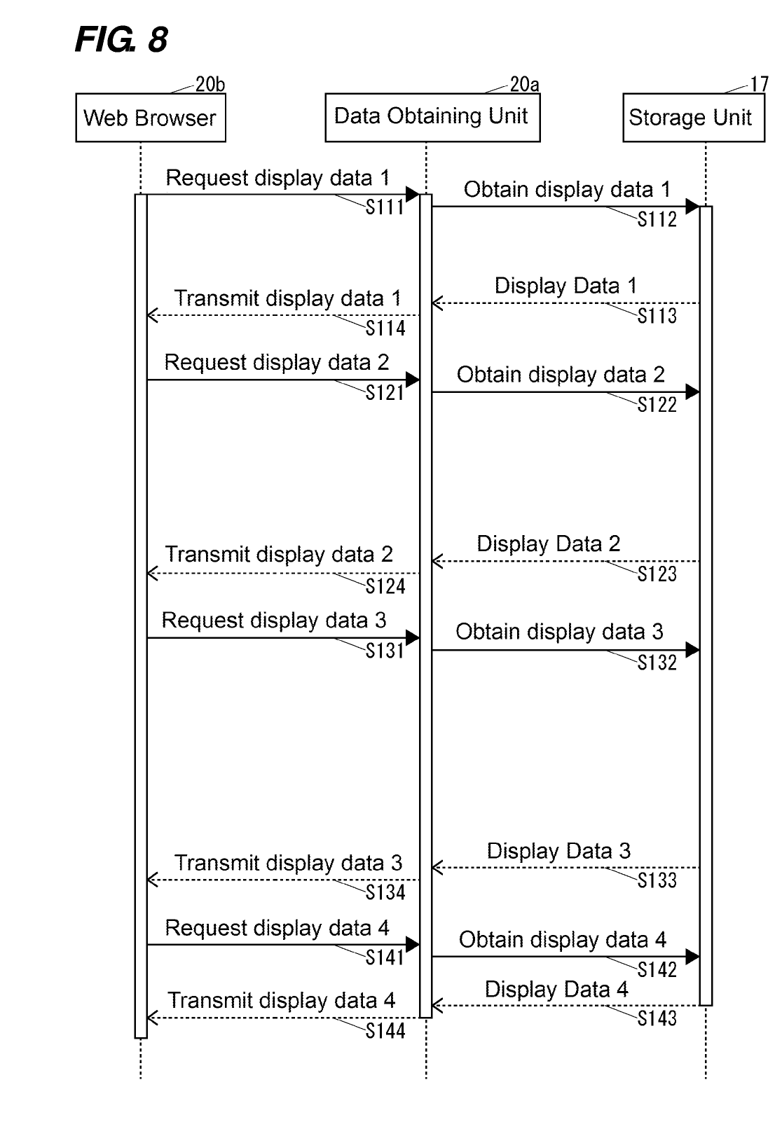

FIG. 8 illustrates the operation of the MFP 10 when the display data obtaining sequential processes are executed for the plurality of items of the display data without performing the parallel process.

In FIG. 8, the control unit 20 executes the display data obtaining sequential process for the display data 1 (Steps S111 to S114), the display data obtaining sequential process for the display data 2 (Steps S121 to S124), the display data obtaining sequential process for the display data 3 (Steps S131 to S134), and the display data obtaining sequential process for the display data 4 (Steps S141 to S144) without performing the parallel process.

The following describes the operation of the MFP 10 when the screen in the copy help screen group is displayed on the display 12.

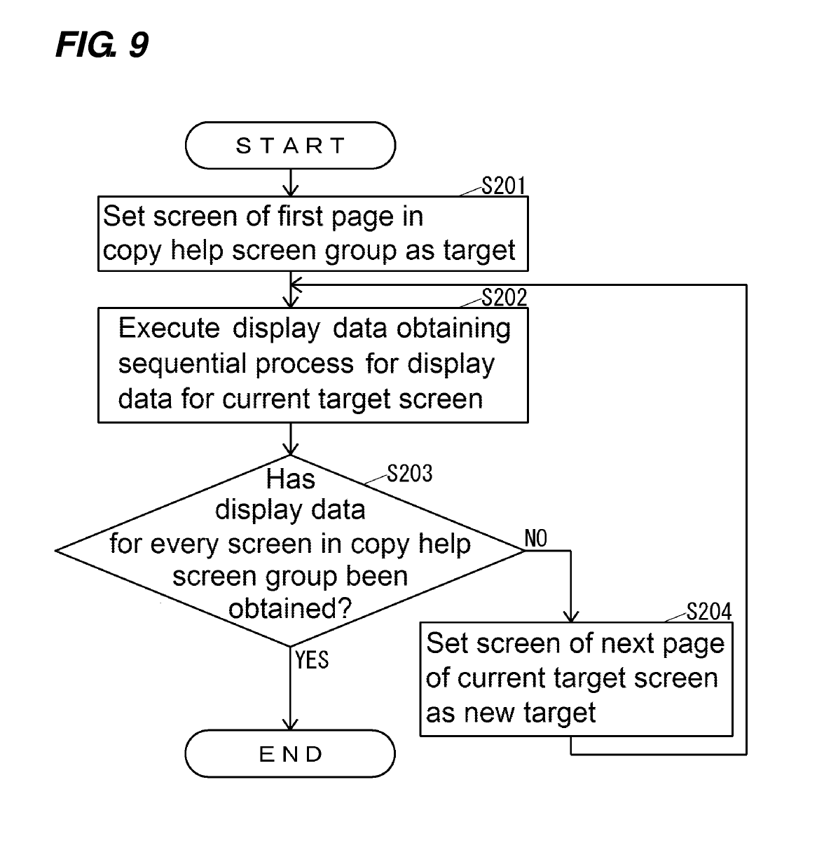

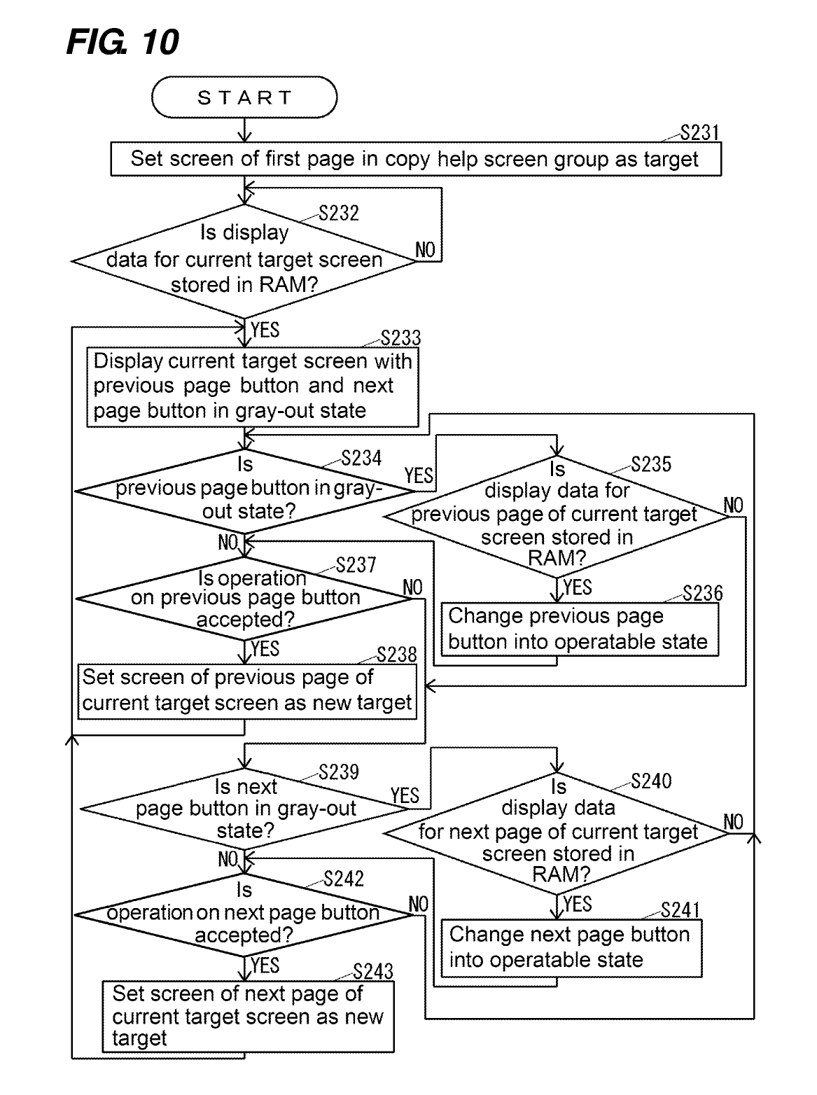

The user can input an instruction (hereinafter referred to as “a copy-help-screen display instruction”) to display the copy help screen on the display 12 to the operation unit 11. When the copy-help-screen display instruction is input to the operation unit 11, the control unit 20 executes the operations illustrated in FIG. 9 and FIG. 10.

FIG. 9 illustrates the operation of obtaining the display data from the storage unit 17 by the MFP 10 when the screen in the copy help screen group is displayed on the display 12.

As illustrated in FIG. 9, the data request unit 20d sets the screen of a first page in the copy help screen group as a target (Step S201).

Next, the data request unit 20d and the data obtaining unit 20a execute the display data obtaining sequential process for the display data 17c for the current target screen (Step S202).

Next, the data request unit 20d determines whether the display data 17c for every screen in the copy help screen group has been obtained (Step S203).

When the data request unit 20d determines that the display data 17c for any screen in the copy help screen group has not yet been obtained in Step S203, the data request unit 20d sets a screen of a next page of the current target screen among the screens in the copy help screen group as a new target (Step S204), and executes the process of Step S202.

When the data request unit 20d determines that the display data 17c for every screen in the copy help screen group has been obtained in Step S203, the data request unit 20d terminates the operation illustrated in FIG. 9.

The MFP 10 performs the operation illustrated in FIG. 9 to execute the display data obtaining sequential processes for the plurality of items of the display data without performing the parallel process as illustrated in FIG. 8.

FIG. 10 illustrates the operation of the MFP 10 when the screen in the copy help screen group is displayed on the display 12.

As illustrated in FIG. 10, the display control unit 20c sets the screen of a first page in the copy help screen group as a target (Step S231).

Next, the display control unit 20c determines whether the display data for the current target screen is stored in the display data storage region 23b of the RAM 23 until the display data for the current target screen is determined to be stored in the display data storage region 23b of the RAM 23 (Step S232).

When the display control unit 20c determines the display data for the current target screen to be stored in the display data storage region 23b of the RAM 23 in Step S232, the display control unit 20c displays the current target screen on the display 12 in a gray-out state based on the display data for the current target screen stored in the display data storage region 23b (Step S233). The gray-out state is a state where it is impossible for the previous page button 32b and the next page button 32c to accept the input of the instruction by the operation unit 11.

Next, the display control unit 20c determines whether the previous page button 32b is in the gray-out state (Step S234).

When the previous page button 32b is determined to be in the gray-out state in Step S234, the display control unit 20c determines whether the display data for the screen of a previous page of the current target screen among the screens in the copy help screen group is stored in the display data storage region 23b (Step S235).

When the display data for the screen of the previous page of the current target screen among the screens in the copy help screen group is determined to be stored in the display data storage region 23b in Step S235, the display control unit 20c changes the previous page button 32b into a state where the input of the instruction is acceptable by the operation unit 11, that is, a non-gray-out state (Step S236).

When the previous page button 32b is determined not to be in the gray-out state in Step S234, or when the process of Step S236 is executed, the display control unit 20c determines whether the operation on the previous page button 32b is accepted (Step S237).

When the operation on the previous page button 32b is determined to be accepted in Step S237, the display control unit 20c sets the screen of the previous page of the current target screen among the screens in the copy help screen group as a new target (Step S238), and executes the process of Step S233.

When the display data for the screen of the previous page of the current target screen among the screens in the copy help screen group is determined not to be stored in the display data storage region 23b in Step S235, or when the operation on the previous page button 32b is determined not to be accepted in Step S237, the display control unit 20c determines whether the next page button 32c is in the gray-out state (Step S239).

When the next page button 32c is determined to be in the gray-out state in Step S239, the display control unit 20c determines whether the display data for the screen of a next page of the current target screen among the screens in the copy help screen group is stored in the display data storage region 23b (Step S240).

When the display data for the screen of the next page of the current target screen among the screens in the copy help screen group is determined to be stored in the display data storage region 23b in Step S240, the display control unit 20c changes the next page button 32c into a state where the input of the instruction is acceptable by the operation unit 11, that is, the non-gray-out state (Step S241).

When the next page button 32c is determined not to be in the gray-out state in Step S239, or when the process of Step S241 is executed, the display control unit 20c determines whether the operation on the next page button 32c is accepted (Step S242).

When the operation on the next page button 32c is determined to be accepted in Step S242, the display control unit 20c sets the screen of the next page of the current target screen among the screens in the copy help screen group as a new target (Step S243), and executes the process of Step S233.

When the display data for the screen of the next page of the current target screen among the screens in the copy help screen group is determined not to be stored in the display data storage region 23b in Step S240, or when the operation on the next page button 32c is determined not to be accepted in Step S242, the display control unit 20c executes the process of Step S234.

When the Return button 32a is operated, the control unit 20 terminates the operation illustrated in FIG. 9 even during the execution of the operation illustrated in FIG. 9, and terminates the operation illustrated in FIG. 10 to terminate the display of the copy help screen on the display 12.

The operation of the MFP 10 when the screen in the copy help screen group is displayed on the display 12 has been described above. However, the same applies to the operation of the MFP 10 when the screen in the manual transition screen group other than the copy help screen group is displayed on the display 12.

The following describes the operation of the MFP 10 when the screen in the standby screen group is displayed on the display 12.

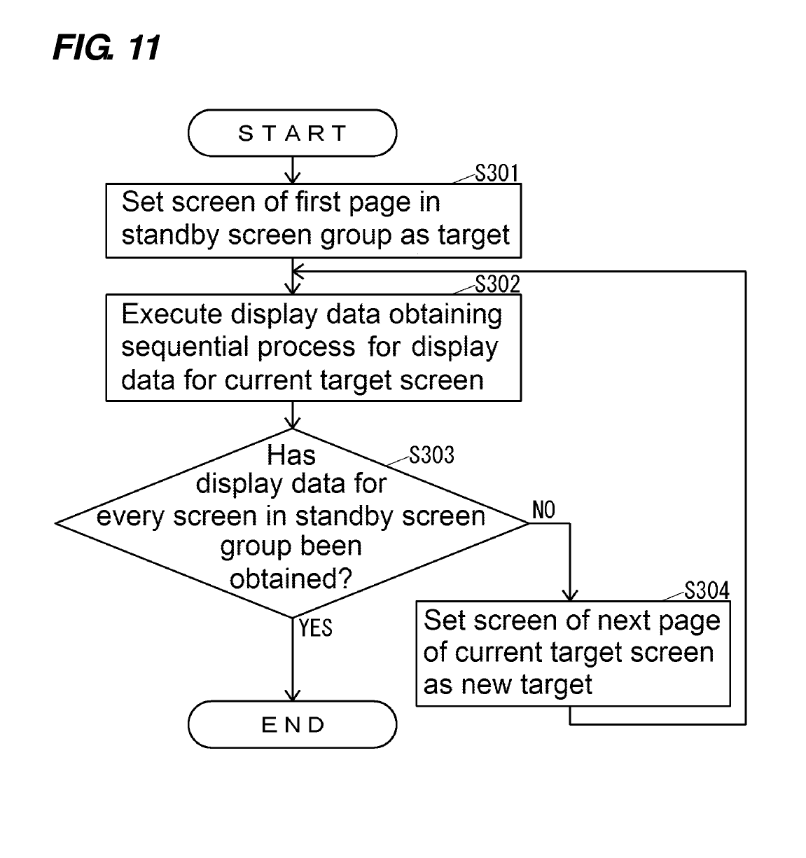

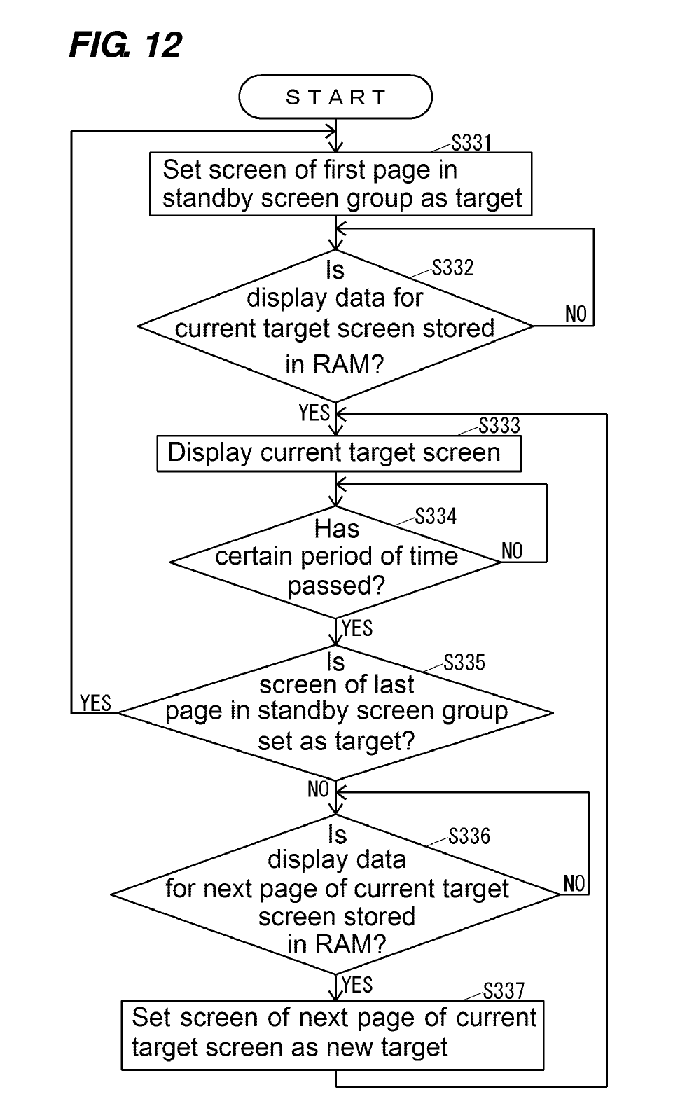

The control unit 20 executes the operations illustrated in FIG. 11 and FIG. 12 when no operation is accepted by the operation unit 11 for a specific period of time while a specific screen is displayed on the display 12.

FIG. 11 illustrates the operation of obtaining the display data from the storage unit 17 by the MFP 10 when the screen in the standby screen group is displayed on the display 12.

As illustrated in FIG. 11, the data request unit 20d sets the screen of a first page in the standby screen group as a target (Step S301).

Next, the data request unit 20d and the data obtaining unit 20a execute the display data obtaining sequential process for the display data 17c for the current target screen (Step S302).

Next, the data request unit 20d determines whether the display data 17c for every screen in the standby screen group has been obtained (Step S303).

When the data request unit 20d determines that the display data 17c for any screen in the standby screen group has not yet been obtained in Step S303, the data request unit 20d sets a screen of a next page of the current target screen among the screens in the standby screen group as a new target (Step S304), and executes the process of Step S302.

When the data request unit 20d determines that the display data 17c for every screen in the standby screen group has been obtained in Step S303, the data request unit 20d terminates the operation illustrated in FIG.

The MFP 10 performs the operation illustrated in FIG. 11 to execute the display data obtaining sequential processes for the plurality of items of the display data without performing the parallel process as illustrated in FIG. 8.

FIG. 12 illustrates the operation of the MFP 10 when the screen in the standby screen group is displayed on the display 12.

As illustrated in FIG. 12, the display control unit 20c sets the screen of a first page in the standby screen group as a target (Step S331).

Next, the display control unit 20c determines whether the display data for the current target screen is stored in the display data storage region 23b of the RAM 23 until the display data for the current target screen is determined to be stored in the display data storage region 23b of the RAM 23 (Step S332).

When the display control unit 20c determines the display data for the current target screen to be stored in the display data storage region 23b of the RAM 23 in Step S332, the display control unit 20c displays the current target screen on the display 12 based on the display data for the current target screen stored in the display data storage region 23b (Step S333).

Next, the display control unit 20c determines whether it has reached a timing where a certain period of time passed after the display of the current target screen on the display 12 in Step S333, until the display control unit 20c determines that it has reached the timing (Step S334).

When, in Step S334, the display control unit 20c determines that it has reached the timing where the certain period of time passed after the display of the current target screen on the display 12 in Step S333, the display control unit 20c determines whether the current target screen is the screen of a last page among the screens in the standby screen group (Step S335).

When the current target screen is determined to be the screen of the last page among the screens in the standby screen group in Step S335, the display control unit 20c executes the process of Step S331.

When the current target screen is determined not to be the screen of the last page among the screens in the standby screen group in Step S335, the display control unit 20c determines whether the display data for the screen of the next page of the current target screen is stored in the display data storage region 23b until the display data for the screen of the next page of the current target screen among the screens in the standby screen group is determined to be stored in the display data storage region 23b (Step S336).

When the display data for the screen of the next page of the current target screen among the screens in the standby screen group is determined to be stored in the display data storage region 23b in Step S336, the display control unit 20c sets the screen of the next page of the current target screen among the screens in the standby screen group as a new target (Step S337), and executes the process of Step S333.

When any operation is accepted by the operation unit 11, the control unit 20 terminates the operation illustrated in FIG. 11 even during the execution of the operation illustrated in FIG. 11, and terminates the operation illustrated in FIG. 12 to terminate the display of the standby screen on the display 12.

The operation of the MFP 10 when the screen in the standby screen group is displayed on the display 12 has been described above. However, the same applies to the operation of the MFP 10 when the screen in the automatic transition screen group other than the standby screen group is displayed on the display 12.

As described above, the MFP 10 executes the display data obtaining sequential processes for the plurality of items of the display data 17c without performing the parallel process (Steps S201 to S204, or Steps S301 to S304), thus reducing the possibility of the occurrence of the error due to the insufficiencies of the performances of the CPU 21 and the RAM 23 used for executing the display data obtaining sequential processes. Accordingly, the MFP 10 ensures smooth transition of the screen (Step S233 or S333).

When the screen of the first page in the specific group constituted of a plurality of screens is displayed on the display 12 (Steps S231 to S233, or Steps S331 to S333), the MFP 10 executes continuous obtaining of the display data 17c for each of the plurality of screens in the group in sequence in a background (Steps S201 to S204, or Steps S301 to S304) until the obtaining of the display data 17c for every screen in the group is completed (YES in Step S203, or YES in Step S303). Accordingly, when a specific condition for the screen transition on the display 12 occurs (YES in Step S237, YES in Step S242 or YES in Step S334), the display data 17c for the screen as a transition destination is less likely not to have been obtained, thus ensuring the smooth screen transition (Step S233 or S333).

When the display data 17c for the screen as the transition destination has not yet been obtained (NO in Step S235, or NO in Step S240), the MFP 10 causes the previous page button 32b or the next page button 32c for the screen as the transition destination to be in the state where the input of the instruction of the screen transition is unacceptable, that is, the gray-out state (Step S233). This ensures reducing the occurrence of a failure where “even if the instruction of the screen transition is input to the previous page button 32b or the next page button 32c in a state where the input of the instruction of the screen transition is acceptable, the screen is not transitioned” when the display data 17c for the screen as the transition destination has not yet been obtained.

When it reaches the specific timing for the screen transition on the display 12 (YES in Step S334), the MFP 10 once halts the screen transition without transitioning to the screen other than the screen as the original transition destination when the display data 17c for the screen as the transition destination has not yet been obtained (NO in Step S336), and transitions to the screen based on the display data 17c as the original transition destination (Step S333) when the display data 17c for the screen as the original transition destination has been obtained (YES in Step S336). This ensures reducing the occurrence of a failure where the order of the screen transition goes wrong.

While the data obtaining unit 20a is achieved by the control unit 20 in the embodiment, the data obtaining unit 20a may be achieved by hardware different from the control unit 20.

While the screen display apparatus of the disclosure is the MFP in the embodiment, the screen display apparatus may be an image forming apparatus other than the MFP, or may be a computer other than the image forming apparatus, for example, a personal computer (PC). However, the image forming apparatus typically includes a CPU and a RAM whose performances are low compared with the PC and similar computer. Accordingly, the disclosure provides a greater advantage.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A screen display apparatus comprising:
a display device;
a display control unit that controls display of a screen on the display device; and
a display data obtaining unit that obtains display data from a source of the display data for the screen; wherein
in a case where the display data for the screen as a transition destination has been already obtained by the display data obtaining unit, the display control unit transitions the screen on the display device based on the display data when a specific condition for the transition of the screen on the display device occurs, and
the display data obtaining unit executes a sequence of processes from a request of the display data to the source to obtaining of the display data from the source for a plurality of items of the display data without performing parallel process; and
the display data obtaining unit starts obtaining the display data for the screen in a group when the display control unit displays the screen of a first page in the group, the group being a specific group constituted of a plurality of the screens, and
the display data obtaining unit continuously executes the obtaining of the display data for each of the plurality of the screens in the group in sequence until the obtaining of the display data for every screen in the group is completed when the obtaining of the display data for the screen in the group is started.

2. The screen display apparatus according to claim 1, further comprising an input device, wherein:
the screen includes a transition instruction accepting region that accepts an input of an instruction of the transition of the screen on the display device by the input device;
the specific condition is a condition where the input of the instruction by the input device is accepted by the transition instruction accepting region; and
the display control unit turns
the transition instruction accepting region for the screen as the transition destination into a state where the input of the instruction is unacceptable by the input device when the display data for the screen as the transition destination has not yet been obtained by the display data obtaining unit, and
the transition instruction accepting region for the screen as the transition destination into a state where the input of the instruction is acceptable by the input device when the display data for the screen as the transition destination has already obtained by the display data obtaining unit.

3. The screen display apparatus according to claim 1, wherein:
the specific condition is a condition having reached a specific timing for the transition of the screen on the display device; and
when the specific condition occurs, the display control unit halts the transition of the screen on the display device until the display data obtaining unit obtains the display data in a state where the display data for the screen as the transition destination has not yet been obtained by the display data obtaining unit, and the display control unit transitions the screen on the display device based on the display data in a state where the display data has been obtained by the display data obtaining unit.

4. A non-transitory computer-readable recording medium storing a screen display program executed by a computer that includes a display device, the screen display program causing the computer to achieve:
a display control unit that controls display of a screen on the display device; and
a display data obtaining unit that obtains display data from a source of the display data for the screen; wherein
in a case where the display data for the screen as a transition destination has been already obtained by the display data obtaining unit, the display control unit transitions the screen on the display device based on the display data when a specific condition for the transition of the screen on the display device occurs, and
the display data obtaining unit executes a sequence of processes from a request of the display data to the source to obtaining of the display data from the source for a plurality of items of the display data without performing parallel process; and
the display data obtaining unit starts obtaining the display data for the screen in a group when the display control unit displays the screen of a first page in the group, the group is a specific group constituted of a plurality of the screens, and
the display data obtaining unit continuously executes the obtaining of the display data for each of the plurality of the screens in the group in sequence until the obtaining of the display data for every screen in the group is completed when the obtaining of the display data for the screen in the group is started.
